(19) United States
(12) Patent Application Publication
(10) Pub. No.: US 2015/0058799 A1
(43) Pub. Date: Feb. 26, 2015

(54) ELECTRONIC DEVICE AND METHOD FOR ADJUSTING USER INTERFACES OF APPLICATIONS IN THE ELECTRONIC DEVICE

(71) Applicant: Chiun Mai Communication Systems, Inc., New Taipei (TW)

(72) Inventor: CHEN-CHAN KAO, New Taipei (TW)

(21) Appl. No.: 14/465,173

(22) Filed: Aug. 21, 2014

(30) Foreign Application Priority Data
Aug. 22, 2013 (CN) 2013103680394

(51) Int. Cl. G06F 3/0484; G06F 3/0488

(52) U.S. Cl. CPC G06F 3/04845; G06F 3/04842; G06F 3/0488
USPC 715/800

(57) ABSTRACT

In a method for adjusting user interfaces of applications in an electronic device, the electronic device is controlled to operate in a specified status for determining a specified window size of the user interfaces of the applications. Operations on a touch screen are received and the specified window size is confirmed according to the received operations. A list of the applications is displayed on the touch screen when the specified window size is confirmed, and one or more applications are confirmed to be executed from the list. The confirmed applications are executed, and window sizes of user interfaces corresponding to the confirmed applications are adjusted according to the specified window size.

### CROSS-REFERENCE TO RELATED APPLICATIONS

This application claims priority to Chinese Patent Application No. 201310368039.4 filed on Aug. 22, 2013 in the State Intellectual Property Office of the People's Republic of China, the contents of which are incorporated by reference herein.

### FIELD

Embodiments of the present disclosure relate to display adjustment technology, and particularly to an electronic device and a method for adjusting user interfaces (UI) of applications in the electronic device.

### BACKGROUND

When an electronic device (for example, a mobile phone or a tablet computer) is executing an application program, the electronic device can display a user interface (UI) of the application program with a full-screen display. If a plurality of applications are executed, a last executed application is often shown on the display. However, a user may not know about other executed applications that are not currently displayed, and also may not be able to quickly and conveniently adjust sizes of UIs of the executed applications according to the user's preferences.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including a user interface adjustment system.

FIG. 2 is a block diagram of one embodiment of the user interface adjustment system of the electronic device of FIG. 1.

FIG. 3 is a diagrammatic view of one embodiment of adjusting a user interface of an application.

FIG. 4 is a flowchart of one embodiment of a method of adjusting user interfaces of applications in the electronic device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

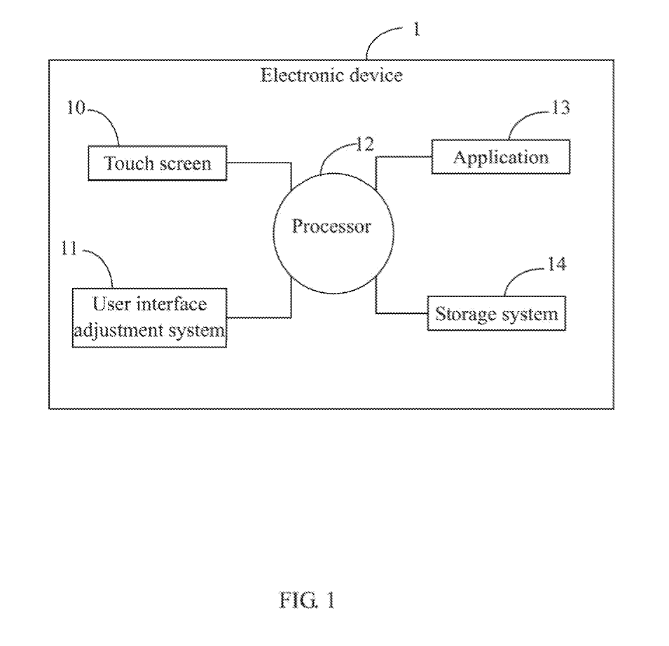

FIG. 1 is a block diagram of one embodiment of an electronic device including a user interface adjustment system. In one embodiment, the electronic device 1 can be a mobile phone, a tablet computer, or any other electronic devices. The electronic device 1 further includes, but is not limited to, a touch screen 10, a user interface adjustment system 11, at least one processor 12, a plurality of applications 13, and a storage system 14.

The touch screen 10 can be a capacitive touch screen or a resistive touch screen supporting touch operations of a finger or a stylus, for example. The touch screen 10 can display user interfaces of the applications 13 in the electronic device 1. The applications 13 can be activated to be executed by the electronic device 1, and one or more user interfaces of the activated applications can be displayed on the touch screen 10. The applications 13 supports a function of adjusting a window size of a user interface (UI).

The at least one processor 12 executes one or more computerized codes and other applications of the electronic device 1 to provide functions of the user interface adjustment system 11. In one embodiment, the storage system 14 may be an internal storage system, such as a random access memory (RAM) for temporary storage of information, and/or a read only memory (ROM) for permanent storage of information. The storage system 14 can also be an external storage card, such as a smart media card or a secure digital card. In one embodiment, the user interface adjustment system 11 can preset a specified window size according to operations of a user of the electronic device 1, and execute one or more selected applications with displaying the UIs of the selected applications with the specified window size.

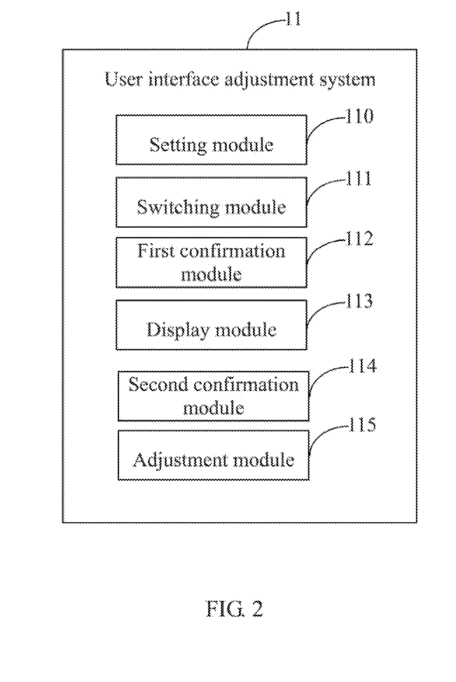

FIG. 2 is a block diagram of one embodiment of the user interface adjustment system 11 included in the electronic device 1 of FIG. 1. In the embodiment, the user interface adjustment system 11 includes, but is not limited to, a setting module 110, a switching module 111, a first confirmation module 112, a displaying module 113, a second confirmation module 114, and an adjustment module 115. The modules 110-115 include computerized code in the form of one or more programs that are stored in the storage system 14. The computerized code includes instructions that are executed by the at least one processor 12 to provide functions of the user interface adjustment system 11.

The setting module 110 configures to preset a trigger instruction for enabling a function of determining a specified window size for the user interfaces of the applications 13. When the electronic device 1 receives the trigger instruction, the electronic device 1 can be operated in a specified status for allowing the user to determine the specified window size. In one embodiment, the trigger instruction can be a command generated by a preset times of presses at any blank area on the touch screen 10, or by pressing different icons on a current page displayed on the touch screen 10 according to a preset sequence. The trigger instruction is different from other instructions (for example, a single click, double clicks, a zoom-in operation) which are existed in the electronic device 1.

The switching module 111 configures to switch the electronic device 1 to operate in the specified status when the electronic device 1 receives the trigger instruction. In one embodiment, the switching module 111 can switch a color of a current page displayed on the touch screen 10 or switch to display a new preset page on the touch screen 10, for presenting that the electronic device 1 is in the specified status. In one embodiment, the new preset page can be a new blank page or a new page including a plurality of window templates with different sizes.

After the electronic device 1 operates in the specified status, the first confirmation module 112 configures to receive operations on the touch screen 10 and confirm the specified window size according to the received operations. If a color of the current page displayed on the touch screen 10 is changed or a new blank page is displayed on the touch screen 10, the first confirmation module 112 confirms the specified window size according to receiving successive coordinate values on the touch screen 10. If a new page including the window templates is displayed on the touch screen 10, the confirmation module 112 receives a clicking operation for selecting a window template and confirms the specified window size according to a size of the selected window template.

For example, if the color of a current page is changed to be another color or a blank new page is displayed on the touch screen 10, the user can continuously draw (slide) a finger across the touch screen 10 to generate a closed path. The closed path has successive coordinate values on the touch screen 10, and a starting point and an ending point of the successive coordinates are same or substantially the same. The confirmation module 112 confirms a rectangle according to a minimum value of X coordinate values (denoted as Xmin), a maximum value of X coordinate values (denoted as Xmax), a minimum value of Y coordinate values (denoted as Ymin), and a maximum value of Y coordinate values (denoted as Ymax) from the received successive coordinate values. The specified window size is determined according to the size of the confirmed rectangle. When the new page including a plurality of window templates is displayed on the touch screen 10, the user can select one of window template according to user's preferences.

The display module 113 configures to display a list of the applications 13 on the touch screen 10 when the specified window size is confirmed. The list of the applications 13 can include, but be not limited to, a name, an icon, a description of each of the applications 13. The user can select one or more applications 13 to be executed from the list displayed on the touch screen 10.

The confirmation module 114 configures to confirm one or more applications 13 to be executed when the one or more application 13 are selected from the list.

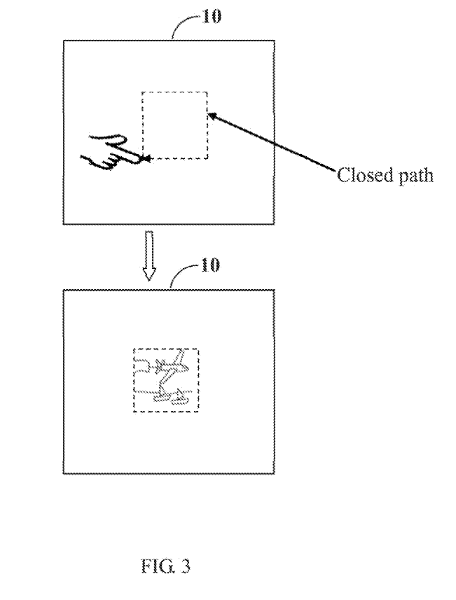

The adjustment module 115 configures to execute the confirmed applications 13 and adjust window sizes of user interfaces corresponding to the confirmed applications 13 according to the specified window size. The executed applications 13 can display the adjusted user interfaces. FIG. 3 is a diagrammatic view of one embodiment of adjusting a user interface of an application. For example, if the user operates a closed path as shown in FIG. 3, the adjustment module 115 can adjust the window size of the user interface for the executed applications 13 to be displayed on the touch screen 10 according to the size of the closed path.

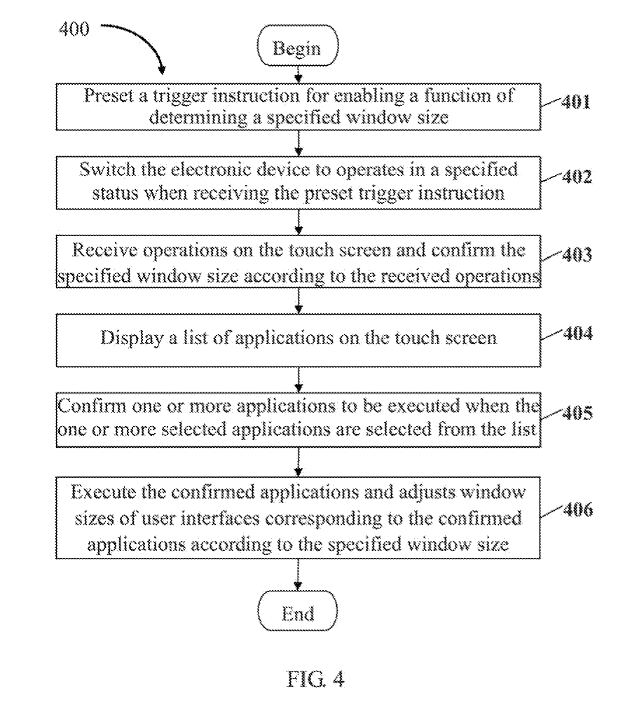

FIG. 4 is a flowchart of one embodiment of a method 400 for adjusting user interfaces of applications in an electronic device. Depending on the embodiment, additional blocks can be added, others removed, and the ordering of the blocks can be changed. In the embodiment, the method 400 is performed by execution of computer-readable software program codes or instructions by at least one processor of a computing device. The method 400 is provided by way of example, as there are a variety of ways to carry out the method. The method 400 described below can be carried out using the configurations illustrated in FIG. 1-FIG. 2, for example, and various elements of these figures are referenced in explaining method 400. Each block shown in FIG. 4 represents one or more processes, methods or subroutines, carried out in the method 400. Additionally, the illustrated order of blocks is by example only and the order of the blocks can change according to the present disclosure. The example method 400 can begin at block 401.

In block 401, the setting module presets a trigger instruction for enabling a function of determining a specified window size for the user interfaces of the applications 13. When the electronic device 1 receives the trigger instruction, the electronic device 1 can operate in a specified status for making the user determine the specified window size. In one embodiment, the trigger instruction can be a command generated by a preset times of presses at any blank area on the touch screen 10, or by pressing different icons on a current page displayed on the touch screen 10 with a preset sequence.

In block 402, when the electronic device 1 receives the trigger instruction, the switching module switches the electronic device 1 to operates in the specified status. In one embodiment, the switching module can switch a color of a current page displayed on the touch screen 10 or switch to display a new preset page on the touch screen 10, for presenting that the electronic device 1 operates in the specified status. In one embodiment, the new preset page can be a new blank page or a new page including a plurality of window templates with different sizes.

In block 403, the first confirmation module receives operations on the touch screen 10 and confirms the specified window size according to the received operations. If a color of a current page is changed or a new blank page is displayed on the touch screen 10, the first confirmation module 112 confirms the specified window size according to receiving successive coordinates on the touch screen 10. If a new page including a plurality of window templates is displayed on the touch screen 10, the confirmation module 112 receives a clicking operation for selecting a window template and confirms the specified window size according to a size of the selected window template.

In block 404, the display module displays a list of the applications 13 on the touch screen 10 when the specified window size is confirmed. The list of the applications 13 can include, but be not limited to, a name, an icon, a description of each of the applications 13.

In block 405, the confirmation module confirms one or more applications 13 to be executed when the one or more selected applications 13 are selected from the list.

In block 406, the adjustment module executes the confirmed applications and adjusts window sizes of user interfaces corresponding to the confirmed applications according to the specified window size.

All of the processes described above can be embodied in, and fully automated via, functional code modules executed by one or more general purpose processors such as the processor 12. The code modules can be stored in any type of non-transitory readable medium or other storage system, such as the storage system 13. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for adjusting user interfaces of applications in an electronic device, the method comprising:
switching the electronic device to operate in a specified status for determining a specified window size of the user interfaces of the applications;
receiving operations on a touch screen of the electronic device, and confirming the specified window size according to the received operations;
displaying a list of the applications on the touch screen when the specified window size is confirmed;
confirming one or more applications to be executed when the one or more applications are selected from the list; and
executing the confirmed one or more applications and adjusting window sizes of the user interfaces corresponding to the confirmed applications according to the specified window size.

2. The method according to claim 1, wherein when the electronic device operates in the specified status, a color of a current page displayed on the touch screen is changed or a new preset page is display on the touch screen, and wherein the new preset page is a new blank page or a new page including a plurality of window templates with different sizes.

3. The method according to claim 2, wherein the specified window size is confirmed by:
receiving successive coordinate values of a closed path on the touch screen when the color of the current page is changed or the new blank page is displayed on the touch screen;
determining a rectangle according to the received successive coordinate value; and
confirming the specified window size according to the size of the rectangle.

4. The method according to claim 2, wherein the specified window size is confirmed by:
receiving a clicking operation for selecting a window template when the new page including the window templates is displayed on the touch screen; and
confirming the specified window size according to a size of the selected window template.

5. The method according to claim 1, further comprising:
presetting a trigger instruction for enabling a function of determining the specified window size for the user interfaces of the applications; and
controlling the electronic device to operate in the specified status when the electronic device receives the trigger instruction.

6. The method according to claim 5, wherein the trigger instruction is a command generated by a preset times of presses at any blank area on the touch screen, or by pressing different icons on a current page displayed on the touch screen according to a preset sequence, and wherein the trigger instruction is different from other instructions which are existed in the electronic device.

7. A non-transitory storage medium storing a set of instructions, when executed by at least one processor of an electronic device, cause the at least one processor to perform a method for user interfaces of applications in the electronic device, the method comprising:
switching the electronic device to operate in a specified status for determining a specified window size of the user interfaces of the applications;
receiving operations on a touch screen of the electronic device, and confirming the specified window size according to the received operations;
displaying a list of the applications on the touch screen when the specified window size is confirmed;
confirming one or more applications to be executed when the one or more applications are selected from the list; and
executing the confirmed applications and adjusting window sizes of user interfaces corresponding to the confirmed applications according to the specified window size.

8. The storage medium according to claim 7, wherein when the electronic device operates in the specified status, a color of a current page displayed on the touch screen is changed or a new preset page is display on the touch screen, and wherein the new preset page is a new blank page or a new page including a plurality of window templates with different sizes.

9. The storage medium according to claim 8, wherein the specified window size is confirmed by:
receiving successive coordinate values of a closed path on the touch screen when the color of the current page is changed or the new blank page is displayed on the touch screen;
determining a rectangle according to the received successive coordinate value; and
confirming the specified window size according to the size of the rectangle.

10. The storage medium according to claim 8, wherein the specified window size is confirmed by:
receiving a clicking operation for selecting a window template when the new page including the window templates is displayed on the touch screen; and
confirming the specified window size according to a size of the selected window template.

11. The storage medium according to claim 7, wherein the method further comprises:
presetting a trigger instruction for enabling a function of determining the specified window size for the user interfaces of the applications; and
controlling the electronic device operates in the specified status when the electronic device receives the trigger instruction.

12. The storage medium according to claim 11, wherein the trigger instruction is a command generated by a preset times of presses at any blank area on the touch screen, or by pressing different icons on a current page displayed on the touch screen according to a preset sequence, and wherein the trigger instruction is different from other instructions which are existed in the electronic device.

13. An electronic device, comprising:
a touch screen;
at least one processor; and
a storage system storing one or more programs, which when executed by the at least one processor, cause the at least one processor to:
switch the electronic device to operate in a specified status for determining a specified window size of user interfaces of applications in the electronic device;
receive operations on the touch screen and confirm the specified window size according to the received operations;
display a list of the applications on the touch screen when the specified window size is confirmed;
confirm one or more applications to be executed when the one or more application are selected from the list; and
execute the confirmed applications and adjust window sizes of user interfaces corresponding to the confirmed applications according to the specified window size.

14. The electronic device according to claim 13, wherein when the electronic device enters into the specified status, a color of a current page displayed on the touch screen is changed or a new preset page is display on the touch screen, and wherein the new preset page is a new blank page or a new page including a plurality of window templates with different sizes.

15. The electronic device according to claim 14, wherein the specified window size is confirmed by:
receiving successive coordinate values of a closed path on the touch screen when the color of the current page is changed or the new blank page is displayed on the touch screen;
determining a rectangle according to the received successive coordinate value; and
confirming the specified window size according to the size of the rectangle.

16. The electronic device according to claim 14, wherein the specified window size is confirmed by:
receiving a clicking operation for selecting a window template when the new page including the window templates is displayed on the touch screen; and
confirming the specified window size according to a size of the selected window template.

17. The electronic device according to claim 13, wherein the one or more programs further cause the at least one processer to:
preset a trigger instruction for enabling a function of determining the specified window size for the user interfaces of the applications; and
control the electronic device to operate in the specified status when the electronic device receives the trigger instruction.

18. The electronic device according to claim 13, wherein the trigger instruction is a command generated by a preset times of presses at any blank area on the touch screen, or by pressing different icons on a current page displayed on the touch screen according to a preset sequence, and wherein the trigger instruction is different from other instructions which are existed in the electronic device.
